(19) United States
(12) Patent Application Publication
(10) Pub. No.: US 2018/0175498 A1
(43) Pub. Date: Jun. 21, 2018

(54) METHOD AND APPARATUS FOR ANTENNA ADJUSTMENT IN WIRELESS COMMUNICATION DEVICES

(71) Applicant: NETWORK PERFORMANCE RESEARCH GROUP LLC, Campbell, CA (US)

(72) Inventors: Erick Kurniawan, San Francisco, CA (US); Chiang-Jen Cheng, Hsinchu City (TW); Terry F. K. Ngo, Bellevue, WA (US)

(21) Appl. No.: 15/381,781

(22) Filed: Dec. 16, 2016

(51) Int. Cl. H01Q 3/00; H01Q 1/24; H01Q 3/06

(52) U.S. Cl. CPC H01Q 3/005; H01Q 3/06; H01Q 1/246

(57) ABSTRACT

Described herein are systems and methods for signal quality optimization in wireless communication networks. In one embodiment, a method of managing a network communication apparatus includes conducting a transmission over a wireless communication network via one or more movable antennas, identifying respective positions of respective movable antennas, obtaining a signal quality metric associated with the transmission, and altering the respective positions of the respective movable antennas in response to the signal quality metric.

### BACKGROUND

The present invention relates to wireless communication networks, and more specifically to signal quality optimization in wireless communication networks.

Advancements in wireless communication technology have led to a significant increase in the use of devices with wireless communication capabilities. This, in turn, has changed the way in which people manage information and communicate. Wireless devices, such as smartphones, tablet computers, laptop computers, and the like, provide users with access to information on an unprecedented scale anywhere wireless communication service is provided.

A wireless communication device sends and/or receives information via one or more antennas. An antenna emits and/or detects information within an area surrounding the antenna that is defined by its radiation pattern. In general, the radiation pattern of an antenna can be more circular or highly directional. If the antenna is designed to be circular, the antenna will provide coverage in a 360 degree area surrounding the antenna, but the range of the antenna will be shorter than that of a directional antenna. Conversely, if the antenna is designed to be directional, the range of the antenna will be longer than that of a circular antenna, but the antenna will only provide coverage over a narrow angle. Due to the tradeoffs between the different types of antenna radiation patterns, any antenna regardless of radiation pattern will have one or more “weak spots” where some locations do not get a good signal to/from the antenna due to its radiation pattern.

### SUMMARY

Various embodiments described herein facilitate the physical adjustment of antennas associated with a wireless network communication device (e.g., a router, a wireless signal extender, etc.) based on signal quality measurements associated with the device. One or more antennas associated with a network communication device, or the device itself, is coupled (e.g., placed upon, fastened to, etc.) a movable surface driven by a motor. A controller causes the motor to alter a position and/or orientation of the movable surface, and by extension the network communication device and/or its antennas, in response to signal quality measurements such as received signal strength indicator (RSSI), packet error rate (PER), and/or other measurements associated with the device and/or its antennas.

In one embodiment, the controller is associated with a set of movement constraints that define valid orientations for the network communication device and/or its antennas. The controller can then cause the movable surface to be positioned according to respective ones of the valid orientations in order to find an orientation that best optimizes signal quality for one or more user devices. This process can be manually triggered or automatic, e.g., automatically performed in response to a signal quality associated with one or more user devices falling below a threshold.

In another embodiment, the motor is configured to rotate the movable surface about an axis substantially orthogonal to the movable surface. The controller can then cycle through and/or otherwise cause the movable surface to be rotated at one or more rotation angles within a valid range of rotation to find an angle that best optimizes signal quality for one or more devices.

By utilizing the antenna adjustment techniques as described herein, an access point and/or other device having movable antennas can be maintained such that any “weak spots” in the coverage provided by the device to one or more users are mitigated. This, in turn, can provide significant increases to signal strength without the use of additional antennas and/or devices.

### BRIEF DESCRIPTION OF THE DRAWINGS

Various embodiments of the subject disclosure are described with reference to the following figures, wherein like reference numerals refer to like parts throughout unless otherwise specified.

FIG. 1 is a high-level block diagram of a network communication apparatus with repositionable antennas.

FIG. 2 is a block diagram showing structure and functionality of an example network communication apparatus with repositionable antennas.

FIG. 3 is an overhead view of the movable surface of the network communication apparatus of FIG. 2.

FIG. 4 is another overhead view of the movable surface of the network communication apparatus of FIG. 2.

FIG. 5 is a diagram of an example wall-mounted network communication apparatus with repositionable antennas.

FIG. 6 is an overhead view of an alternative implementation of the movable surface of the network communication apparatus of FIG. 2.

FIG. 7 is a functional block diagram of a system for adjusting antennas of a network communication device.

FIG. 8 is a diagram showing an example antenna radiation pattern adjustment as performed in accordance with various embodiments described herein.

FIG. 9 is a high-level block diagram of an apparatus that facilitates antenna adjustment for a separate network communication device.

FIG. 10 is a functional block diagram showing example operation of the apparatus of FIG. 9.

FIG. 11 is a flow diagram of a method for managing a network communication apparatus.

### DETAILED DESCRIPTION

The present invention relates to wireless communication networks, and more specifically to signal quality optimization in wireless communication networks. Various embodiments described herein facilitate the physical adjustment of antennas associated with a wireless network communication device (e.g., a router, a wireless signal extender, etc.) based on signal quality measurements (e.g., RSSI, PER, etc.) associated with the device. By utilizing the antenna adjustment techniques as described herein, signal strength can be improved by adjusting the antenna radiation pattern of a network communication device such that overlap between one or more user devices and the antenna radiation pattern is increased.

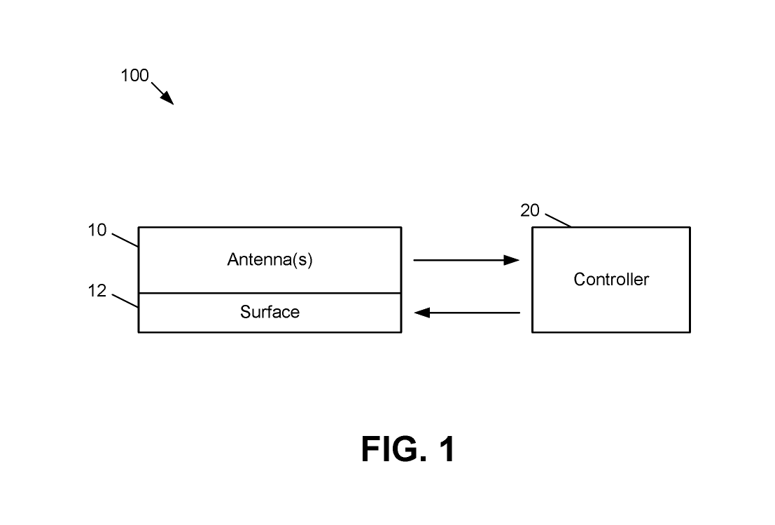

FIG. 1 illustrates an example apparatus 100 with antenna adjustment and signal strength optimization functionality as described herein. The apparatus is a network communication apparatus that can communicate with one or more other devices over one or more wireless communication networks via antenna(s) 10. The antenna(s) 10 can be configured for communication according to any suitable wireless communication standard or protocol or combination thereof. These standards and/or protocols can include, but are not limited to, Wi-Fi (e.g., IEEE 802.11a/b/g/n, etc.), Bluetooth, cellular communication standards (e.g., 2G, 3G, LTE and/or other 4G standards, etc.), and/or any other communication standards and/or protocols presently existing or developed in the future. Further, the antenna(s) 10 can be configured to communicate according to the same protocol and/or different protocols. For instance, a first antenna can be configured to communicate via a first protocol (e.g., Wi-Fi), a second antenna could be configured to communicate according to a second protocol (e.g., Bluetooth), and so on. A single antenna can also be configured for communication according to multiple protocols either simultaneously or non-simultaneously. Additionally, respective antennas 10 can be configured to communicate according to the same communication standard but within different frequency bands or ranges. For instance, a first antenna can be configured to communicate at a first frequency band (e.g., a frequency band centered around approximately 2.4 GHz), a second antenna can be configured to communicate at a second frequency band (e.g., a frequency band centered around approximately 5 GHz), and so on.

As further shown in FIG. 1, respective antennas 10 are mounted on and/or otherwise physically coupled to a surface 12. The surface 12 is a movable surface that is configured to alter respective orientations of respective ones of the antennas 12, e.g., by moving between valid orientations (e.g., from a first orientation to a second orientation, from a second orientation to a third orientation, etc.), thereby causing a similar change in orientation to the antenna(s) 10 physically coupled to the surface 12. While only a single surface 12 is shown in FIG. 1 for simplicity of illustration, multiple surfaces 12 could be used and coupled to different ones of the antennas 10. For instance, a first surface 12 can be coupled to a first antenna 10, a second surface can be coupled to a second antenna 10, etc.

Apparatus 100 further includes a controller 20 that is communicatively coupled to the antenna(s) 10 and the surface 12, e.g., via one or more wired and/or wireless communication links. In an aspect, the controller 20 can communicate with the antenna(s) and/or surface 12 via a system bus and/or another hardwired connection that facilitates communication between the controller 20 and other components of the apparatus 100. Alternatively, a wireless communication link can be established between the controller 20 and antenna(s) 10, which could additionally be used to facilitate indirect communication between the controller 20 and surface 12 via the antenna(s) 10. Other communication types and/or links, or combinations thereof, could also be used. Further, communication types and/or links used by the controller 20 for communicating with the antenna(s) 10 can be the same as, or different from, communication types and/or links used by the controller 20 for communicating with the surface 12. While the controller 20 is shown in FIG. 1 as a standalone component, the controller 20 can be implemented wholly or in part by a microcontroller that regulates communication via the antenna(s) 10 (e.g., a communication chipset that controls communication over Wi-Fi, Bluetooth, etc.) and/or any other components of the apparatus 100 in addition to, or in place of, a standalone component.

The controller 20 can be configured to instruct the surface 12 to alter its position and/or orientation, thereby causing the surface 12 to alter the respective orientations of antenna(s) 10 by nature of their coupling to the surface 12. The controller 20 can further be operable to instruct movement of the surface 12 in any spatial dimension (e.g., x, y, and/or z), rotational dimension (e.g., roll, pitch, and/or yaw) and/or any combination thereof.

In one aspect, the surface 12 is configured to reposition and/or reorient itself according to a set of movement constraints that defines a plurality of valid orientations for the surface 12 and antenna(s) 10. The movement constraints can be at least partially based on mechanical limitations of the apparatus 100 and/or surface 12. For instance, the surface 12 can be fixed in position and mechanically limited (e.g., by an axle or other means) to rotation along an axis substantially orthogonal to the surface 12. In this case, the set of movement constraints can correspond to a range of valid rotation angles. Other considerations can also be used in generating and/or otherwise defining the set of valid orientations, provided that none of the set of valid orientations exceeds the range of motion of which the surface 12 is mechanically capable. In one example, the controller 20 can define the set of valid orientations for the surface 12 by starting from an initial set of orientations (e.g., a “master” set) and removing from the initial set any orientations that are incompatible with the mechanical configuration of the surface 12.

The controller 20 can be configured to instruct movement of the surface 12 automatically without user intervention. In one example, the controller 20 provides movement instructions at predefined time intervals. The time intervals at which movement instructions are provided can be periodic, random, and/or defined in any other suitable manner. In another example, the controller 20 can obtain a measured signal quality associated with respective antennas 10 and causes the surface 12 to alter the respective orientations of the antennas 10 in response to the measured signal quality. For instance, the controller 20 can instruct movement of the surface 12 and its coupled antenna(s) 10 based on criteria such as received signal strength indicator (RSSI), packet error rate (PER), and/or other data associated with communications using the antenna(s) 10. Antenna movement based on signal quality can be triggered by user input and/or automatically, e.g., in response to a measured signal quality falling below a threshold signal quality. Techniques by which the controller 20 manipulates the position and/or orientation of the surface 12 and/or antenna(s) 10 based on signal quality are described in further detail below.

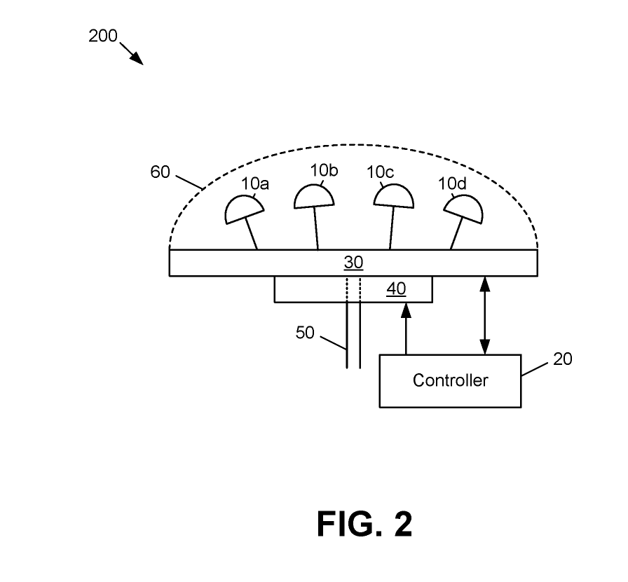

Turning next to FIG. 2, an example network communication apparatus 200 is illustrated that includes repositionable antennas, here four antennas 10a-d, in accordance with various aspects herein. It should be appreciated that while apparatus 200 is illustrated as having four antennas 10a-d, any number of antennas could be used.

As shown in FIG. 2, the antennas 10a-d are mounted on or otherwise attached to a mounting platform 30 that is adapted to receive the antennas 10a-d. The mounting platform 30 is, in turn, coupled to a motor 40 that is configured to displace the mounting platform 30. In this way, the mounting platform 30 and the motor collectively operate in a similar manner to the surface 12 shown in FIG. 1.

In one embodiment, the mounting platform 30 is a printed circuit board (PCB) and/or other component that is operable to convey information between the antennas 10a-d and other components of the apparatus 200. Thus, as shown in FIG. 2, the controller 20 can receive information from the antennas 10a-d either directly or indirectly via the mounting platform 30. While not shown in FIG. 2, the controller 20 and/or one or more components associated with the controller 20 (e.g., communication chipsets or the like) can also be implemented by and/or fixed upon a PCB associated with the mounting platform 30. In another embodiment, the antennas 10a-d are physically coupled to the mounting platform 30 and communicatively coupled to the controller 20 and/or components associated with the controller 20 via wires and/or other means independently from the mounting platform 30. Irrespective of the physical configuration of the controller 20 and the mounting platform 30, the controller 20 is operable to receive signal quality information from the antennas 10a-d and control movement of the mounting platform 30 via the motor 40 as generally described herein.

The apparatus 200 further includes an input cable 50 that is coupled to the mounting platform 30 and/or motor 40. The input cable 50 can be used to provide power to the mounting platform 30 and/or motor 40. Additionally or alternatively, the input cable 50 can be used to provide a wired communication link between the antennas 10a-d and one or more communication networks, e.g., if the apparatus 200 functions as a wireless router. While only one input cable 50 is shown in FIG. 2, multiple input cables could be used. For instance, separate input cables 50 can be utilized for power and network connectivity. In one aspect, the input cable 50 is connected to the apparatus 200 using a connector that facilitates movement of the mounting platform 30 via the motor 40. For instance, a variation of the U.FL connector manufactured by Hirose Electric Group that permits angular movement could be utilized to enable the mounting platform 30 to rotate about the input cable 50 while the input cable 50 remains stationary. Other connection types could be used.

As further shown in FIG. 2, the antennas 10a-d and a top (first) surface of the mounting platform 30 can additionally be housed within a housing 60. The housing 60 can be composed of any material (e.g., plastic, glass, etc.) suitable for forming a barrier between the antennas 10a-d and an environment surrounding the apparatus 200. While the housing 60 is illustrated in FIG. 2 as having a convex shape, the housing 60 can take any shape that is suitable for at least partially enclosing the antennas 10a-d. Additionally, while the housing 60 is shown in FIG. 2 as enclosing only a top surface of the mounting platform 30, the housing 60 can be sized such that it encloses the entire mounting platform 30 or only a portion of the top surface of the mounting platform 30.

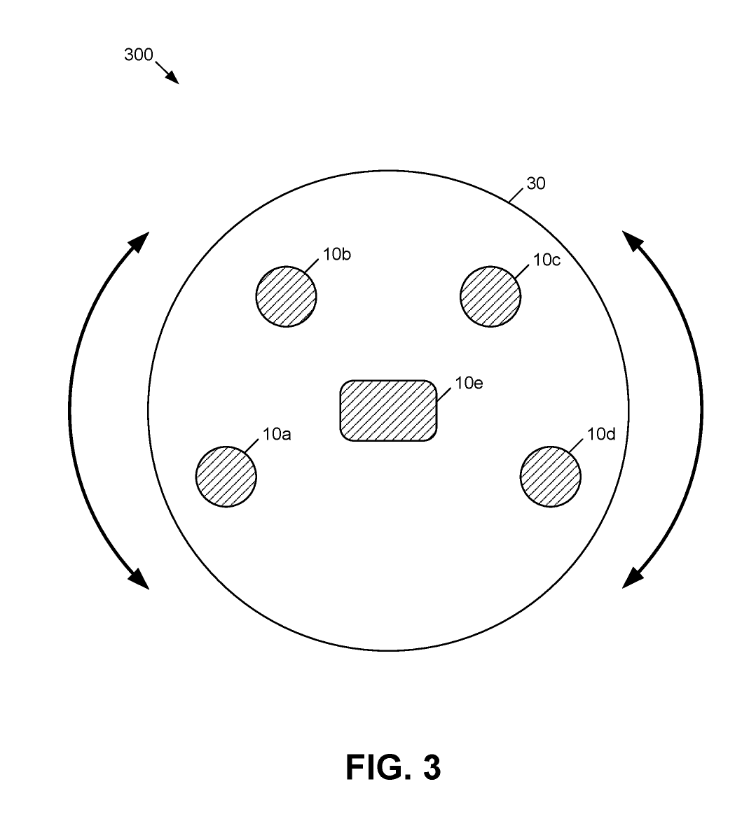

FIG. 3 illustrates a top view 300 of the apparatus 200 shown in FIG. 2. Here, the mounting platform 30 is substantially circular and the antennas 10a-d are arranged radially around the mounting platform 30. As noted with respect to FIG. 2, the antennas 10a-d can be communicatively coupled to the controller 20 (not shown in top view 300) via the mounting platform 30 itself and/or by the use of wires, cables, or other means for operatively coupling the antennas 10a-d and controller 20. The mounting platform 30 may, in turn, be connected to one or more power or network sources via input cable(s) 50 (not shown in top view 300) as described above.

In addition to antennas 10a-d, the top view 300 illustrates a fifth antenna 10e positioned substantially in the center of the mounting platform 30. The antennas 10a-e shown in top view 300 can be configured to communicate according to the same or different communication standards and at the same or different frequency bands, as generally described above. By way of non-limiting example, antennas 10a-d can be configured to operate at a 5 GHz frequency band and antenna 10e can be configured to operate at a 2.4 GHz frequency band. Other configurations are also possible.

As further shown by top view 300, the mounting platform 30 can be configured to rotate (e.g., using the motor 40) about an axis substantially orthogonal to the mounting platform 30, e.g., such that the rotation of the mounting platform 30 remains in the same plane as that represented by top view 300. The mounting platform 30, however, could also be configured to move and/or reorient in other manners in addition to the rotation shown in FIG. 3. Additionally, while top view 300 illustrates rotation of the mounting platform 30 and all antennas 10a-e placed thereon, one or more of the antennas 10a-e could be configured to rotate about the mounting platform 30 and/or otherwise move with respect to the mounting platform 30 independently of the mounting platform 30 and/or the other antennas 10a-e. To these ends, the mounting platform 30 could include tracks, guides, magnetic couplings, and/or other means for defining the permissible movement path of an individual antenna independently of the mounting platform 30.

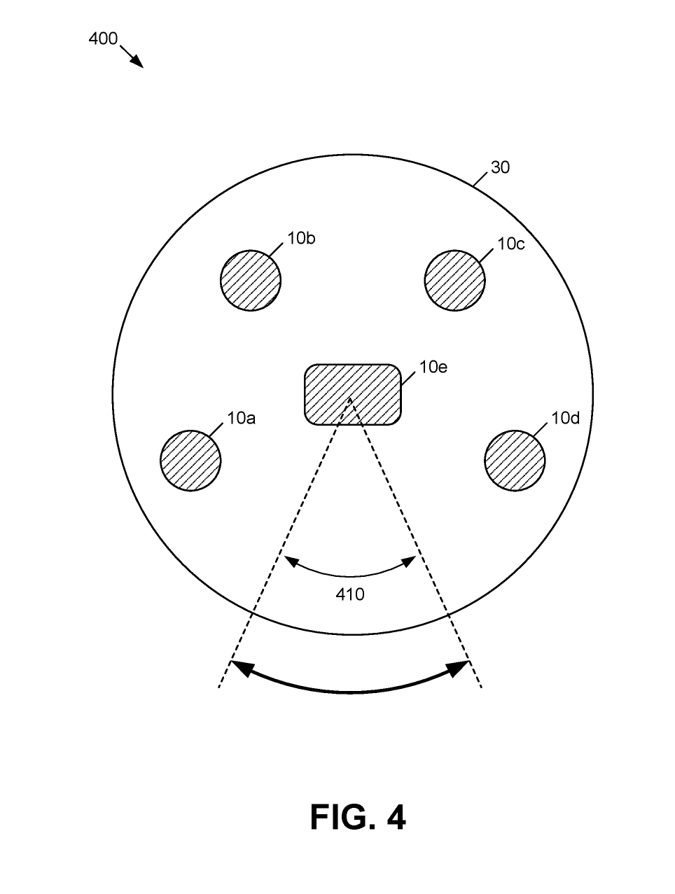

Turning next to FIG. 4, another top view 400 of apparatus 200 is illustrated. In an aspect, the mounting platform 30 and antennas 10a-e shown in top view 400 can rotate about a center of the mounting platform 30 in a similar manner to that described above with respect to top view 300. As further illustrated by top view 400, the permissible range of rotation of the mounting platform 30 can be constrained to an angular range 410. The angular range 410 can be defined within the set of valid orientations for the mounting platform 30 and antennas 10a-e that is utilized by the controller 20 in instructing movement of the mounting platform 30. Here, the angular range 410 defines a limited permissible range of rotation for the mounting platform, e.g., a range including less than full 360-degree rotation. The set of valid orientations could in some cases include additional valid movement ranges for the mounting platform 30. For instance, the set of movement constraints could include the angular range 410 as well as one or more permissible ranges of linear motion. Other constraints on the movement of the mounting platform 30 could also be used.

In an aspect, the angular range 410 can be defined by the controller 20 based on mechanical limitations of the mounting platform 30 and/or its coupled components. For instance, if the motor 40 that rotates the mounting platform 30 is locked to a limited range of rotation, the angular range 410 can be configured to be no larger than the range of rotation of the motor 40. Additionally, based on the length and/or configuration of the input cable 50, the angular range 410 can be configured in order to minimize rotation or twisting of the input cable 50 and to prevent damage to the apparatus due to excess twisting of the input cable 50.

In another aspect, the angular range 410 can be configured based on device performance. For instance, in some cases the controller 20 can be configured to rotate and/or otherwise move the mounting platform 30 substantially slowly in order to preserve beamforming calibration of the antennas 10a-e and/or other aspects of the configuration of the antennas 10a-e. Accordingly, the angular range 410 can be configured to a relatively small value (e.g., 10 degrees, 20 degrees, etc.) in order to limit the amount of time utilized for rotating and/or otherwise moving the mounting platform 30. User input can additionally or alternatively be used for configuration of the angular range 410. As an example, a user can be given a set of options for values of the angular range 410 (e.g., 10/20/30 degrees, etc.) such that the user can select the angular range 410 based on their preferences for device speed and performance.

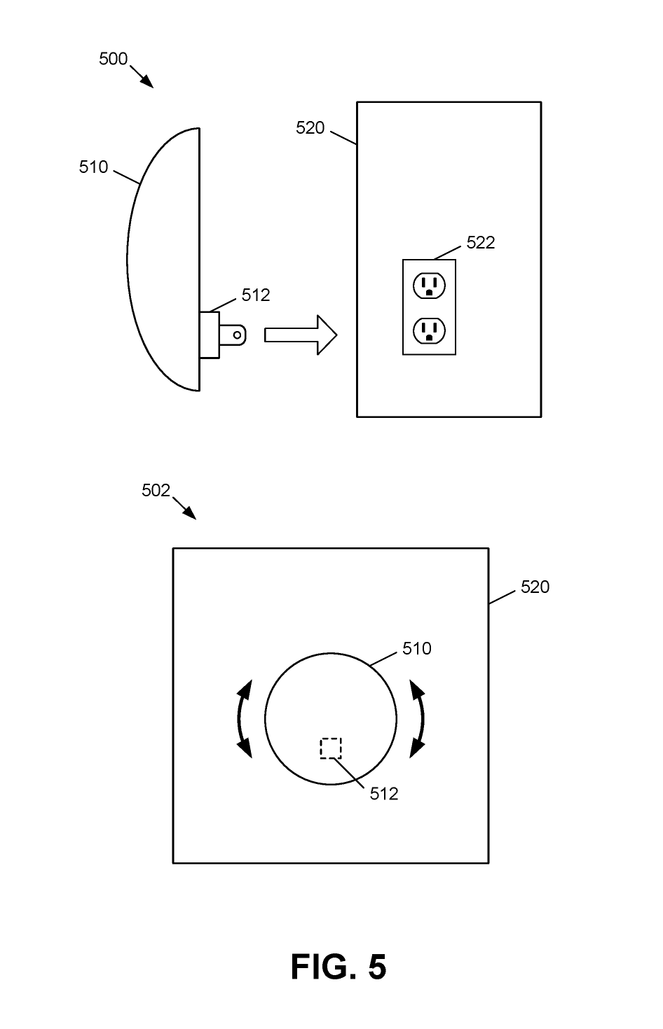

Turning next to FIG. 5, diagrams 500 and 502 illustrate an example wall-mounted network communication apparatus 510 with repositionable antennas in accordance with various aspects described herein. As shown in diagram 500, the apparatus 510 includes a plug 512 that provides power to the apparatus 510 and at least partially secures the apparatus 510 to a wall 520 via an electrical outlet 522. While not shown in FIG. 5, the apparatus 510 can include additional means for securing the apparatus 510 to the wall 520, such as an adhesive, a mounting bracket that attaches the apparatus 510 to the wall 520 via screws and/or other means, or the like.

Diagram 502 illustrates operation of the apparatus 510 upon connection of the plug 512 to the electrical outlet 522. In response to received signal quality parameters and/or other triggering conditions as described herein, the apparatus 510 can rotate about an axis substantially orthogonal to the wall 520, e.g., such that the plane of rotation of the apparatus 510 remains substantially parallel to the wall 520. Other movement types could also be used; for example, the apparatus 510 could alternatively be configured to move linearly within a predefined three-dimensional range of the starting point of the apparatus 510.

In the example shown in FIG. 5, the apparatus 510 operates as a wireless signal extender (e.g., Wi-Fi extender, Bluetooth extender, etc.) or repeater by receiving wireless signals corresponding to communication within a given network (e.g., a home network for an area at which the apparatus 510 is placed, etc.) and retransmitting at least a portion of the received signals. The apparatus 510 can optionally perform one or more operations on the signals prior to retransmission, e.g., amplification, noise reduction, or the like. In another example, the apparatus 510 can operate as a wireless router, in which case the apparatus 510 can include an input cable 50 for supplying network connectivity between the apparatus 510 and one or more devices with which it communicates. As described above with respect to FIG. 4, the apparatus 510 in such an implementation can be configured with a limited range of rotation and/or other movement based on the length and/or configuration of the input cable 50 to avoid causing damage to the input cable 50 and/or apparatus 510 due to over-rotation.

The apparatus 510 shown in FIG. 5 can be configured to rotate in any suitable manner for repositioning and/or reorienting the antenna(s) within the apparatus 510. For example, the apparatus 510 can be configured such that substantially the entire housing of the apparatus 510 with the exception of the plug 512 is rotated. Alternatively, the apparatus 510 can be configured such that the housing remains in place while a PCB and/or other antenna mounting surface, or individual antennas, are rotated or otherwise moved inside the housing. Other configurations are also possible.

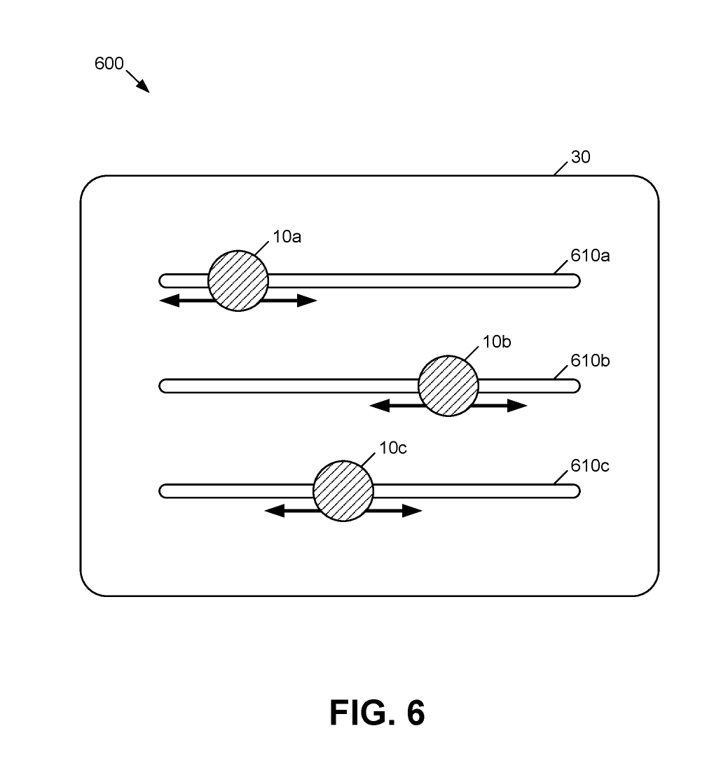

Turning next to FIG. 6, a top view 600 of an alternative implementation of apparatus 200 is illustrated. Here, the apparatus 200 includes three antennas 10a-c that are configured to move linearly along the mounting platform 30 via respective sliders or tracks 610a-c. As shown by FIG. 6, the antennas 10a-c are independently positionable, e.g., via separate motors and/or a single motor configured to drive multiple independent outputs. Alternatively, the movement of one or more of the antennas 10a-c could be locked to that of another one(s) of the antennas, e.g., the antennas 10a-c could instead either wholly or in part move together. While top view 600 illustrates the antennas 10a-c moving along respective linear one-dimensional tracks 610a-c, it should be appreciated that the antennas 10a-c could be configured for movement in three-dimensional space in any suitable manner, either with or without the use of guide mechanisms such as tracks 610a-c. Additionally, while tracks 610a-c are illustrated as grooves within the mounting platform 30, the tracks can be implemented in any suitable manner, such as by magnetically coupling the antennas 10a-c to the mounting platform via magnets on an opposite side of the mounting platform 30 and subsequently moving respective antennas 10a-c via their corresponding magnets.

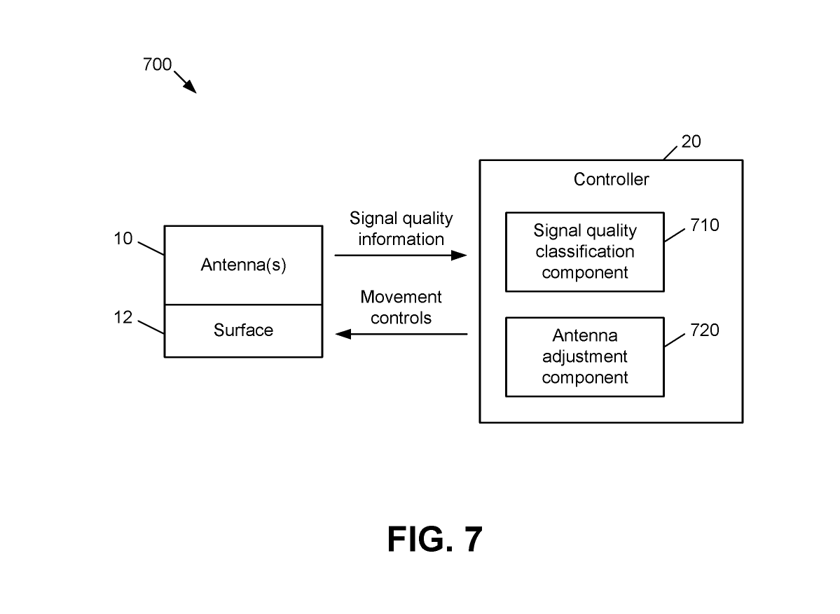

Referring next to FIG. 7, a system 700 for adjusting the antennas 10 of a network communication device according to signal quality information is illustrated. The system 700 includes one or more antennas 10 physically and/or operatively coupled to a movable surface 12 in a similar manner to that described above with respect to apparatus 100. In addition, the system 700 includes a controller 20 that monitors signal quality associated with the antennas 10 and provides movement controls to the surface 12 in response to the signal quality. While not shown in system 700, the surface 12 can include and/or be associated with one or more components that facilitate movement of the surface, such as a motor 40 or the like. Additionally, the controller 20 can be located within the same device as the antennas 10 and surface 12 or a different device. In an implementation where the controller 20 is located at a different device than the antennas 10 and surface 12, the controller 20 can receive signal quality information from the antennas 10 and/or other sources and transmit responsive movement controls back to the antennas 10, which can then provide the movement controls to the surface 12.

As shown in FIG. 7, the controller 20 includes a signal quality classification component 710 that obtains information related to a signal quality associated with one or more devices communicating with the antennas 10. For instance, the signal quality information can relate to a measured RSSI, PER, and/or other metrics as observed at one or more client devices from the antennas 10. Other metrics and/or combinations thereof could also be used. Based on the received signal quality information, an antenna adjustment component 720 at the controller determines an appropriate adjustment to the position and/or orientation of the respective antennas 10 and provides this information to the antennas 10 and/or surface 12 in the form of movement controls (instructions).

In an aspect, the controller 20 can be configured with one or more trigger conditions for antenna adjustment. For instance, the signal quality classification component 710 can monitor (e.g., periodically, randomly, upon user instruction, etc.) a signal quality associated with one or more user devices and initiate antenna adjustment if the monitored signal quality is less than a predefined threshold signal quality. Alternatively, the controller 20 can initiate antenna adjustment at regular and/or irregular time intervals (e.g., according to a schedule, etc.), upon receiving a user request for antenna adjustment, and/or upon any other suitable event. Irrespective of the event that triggers operation of the controller 20, antenna adjustment operations can be performed automatically by the controller 20 without further user input or intervention.

In one example, the controller 20 manages adjustment of the antennas 10 based on a set of candidate antenna orientations. The candidate antenna orientations can be generated and/or otherwise obtained based on the set of movement constraints for the antennas 10 and/or surface 12. For instance, the candidate antenna orientations can correspond to positions, rotation angles, or the like, within a permissible range of motion defined by the movement constraints. The candidate antenna orientations can span the movement constraints wholly or in part. As an example, candidate rotation angles can be limited to a specified number of degrees in either direction of a current angular position of the platform 12, even if the movement constraints allow for a greater range of movement, provided that the candidate rotation angles do not fall outside the movement constraints.

Upon identifying a triggering event as described above, the controller 20 can step through respective ones of the candidate antenna orientations to find an antenna orientation that substantially optimizes the measured signal quality reported to the signal quality classification component 710. For instance, the antenna adjustment component 720 can cause the antennas 10 and/or the platform 12 to become oriented according to respective candidate antenna orientations, and the signal quality classification component 710 can obtain respective signal qualities for the candidate antenna orientations and select one of the candidate antenna orientations based on their respective signal qualities. For instance, the signal quality classification component 710 can select a candidate antenna orientation having a highest signal quality. Other metrics for selecting a candidate antenna orientation could also be used. Upon selection of a candidate antenna orientation, the antenna adjustment component 720 can instruct the antennas 10 and/or platform 12 to return to the selected orientation if the antennas 10 and/or platform 12 have moved from the selected orientation during the selection process.

In an aspect, the set candidate antenna orientations can be traversed substantially sequentially to minimize the amount of travel required by the antennas 10 and/or platform 12. By way of specific, non-limiting example, if the platform 12 is configured for rotational movement, the antenna adjustment component 720 can rotate the platform 12 through the range of candidate rotation angles while the signal quality classification component 710 measures signal qualities associated with each of the candidate angles. This process could be conducted unidirectionally or bidirectionally, e.g., for a range of candidate rotation angles that are both clockwise and counter-clockwise relative to the starting point. Similar techniques could also be used for analyzing candidate antenna orientations in two-dimensional or three-dimensional linear space, or a combination of rotation and linear motion.

In another aspect, the controller 20 can analyze each of the candidate antenna orientations and subsequently select a candidate antenna orientation that yielded the highest signal quality. Alternatively, the controller 20 can analyze less than all of the candidate antenna orientations. For instance, if a candidate antenna orientation is found to be associated with a signal quality that is higher than a threshold signal quality (which may or may not be the same threshold as that used to trigger adjustment), the controller 20 can halt its analysis and instruct the antennas 10 and/or platform 12 to remain at that orientation without stepping through all of the candidate antenna orientations.

The signal qualities analyzed by the signal quality classification component 710 during antenna adjustment can correspond to signal quality data measured by a single device or multiple devices. If signal quality measurements associated with multiple devices are used, the signal quality classification component 710 can utilize an average or weighted average of the measurements. Further, signal quality measurements can be received by the controller 20 from the antennas 10 and/or one or more devices communicating with the antennas 10.

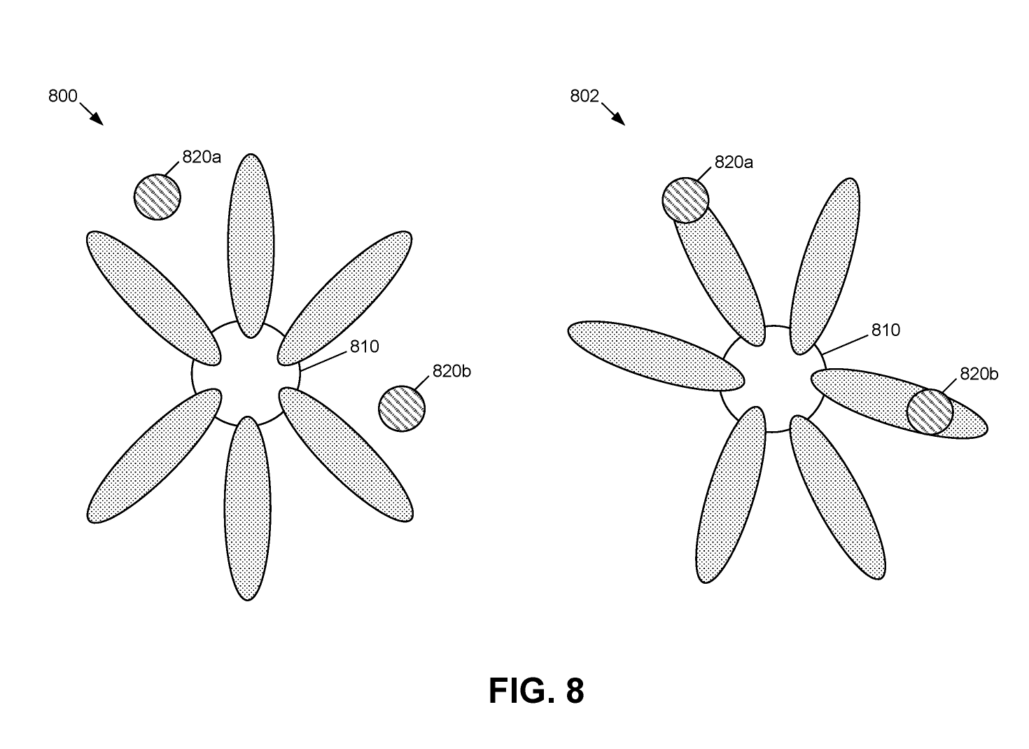

Referring next to FIG. 8, diagrams 800 and 802 illustrate a non-limiting example of an antenna adjustment operation that can be performed by system 700. Diagram 800 illustrates an example antenna radiation pattern for a device 810 (e.g., router, signal extender, etc.) utilized by two user devices 820a-b prior to adjustment. The elliptical shaded regions in diagram 800 correspond to the radiation beams formed by the antennas of the device 810. As shown in diagram 800, both user devices 820a-b are located in a null area or “dead zone” between beams and therefore will receive a weak signal from the device 810. Diagram 802 illustrates the antenna radiation pattern of the device 810 after adjustment. Here, the radiation beams have been rotated such that both of the user devices 820a-b are substantially within the radiation beams of the device 810, thereby substantially improving the signal quality to the user devices 820a-b.

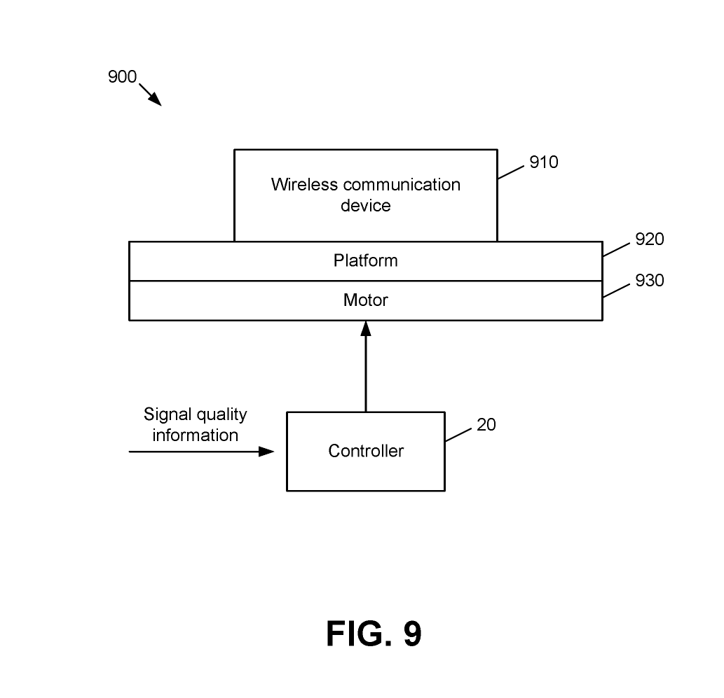

Turning to FIG. 9, a system 900 for adjusting antenna positions and/or orientations for a wireless communication device 910 is illustrated. The system 900 includes a platform 920 having a first (e.g., top, front) surface adapted to receive the network communication device 910, e.g., by placing the network communication device 910 on the platform 920, affixing and/or attaching the network communication device 910 to the platform 920, etc. The system 900 further includes a motor 930 and a controller 20 that operate to provide antenna adjustment for the wireless communication device 910 as described herein. The wireless communication device 910 can be a wireless router, a wireless signal extender, a mobile phone, a tablet or laptop computer, a cellular base station (e.g., a femtocell), and/or any other device configured for communication over a wireless communication network. In an aspect, the platform 920, motor 930, and controller 20 collectively comprise an apparatus for performing adjustments to an antenna radiation pattern associated with the wireless communication device 910. The functionality of the platform 920, motor 930, and controller 20 can be implemented by a single physical device or distributed among multiple physical devices. In another aspect, the platform 920 can provide a flat horizontal surface, a mounting bracket, and/or other means for non-permanently coupling the wireless communication device 910 and the platform 920 in order to enable use of the platform 920 with multiple different devices at different times.

The motor 930 is coupled to the platform 920 and configured to alter the position and/or orientation of the platform 920, thereby also altering the position and/or orientation of the wireless communication device 910 placed upon and/or affixed to the platform 920. In an aspect, the motor 930 is operatively coupled to a second (e.g., bottom, back) surface of the platform 920 at a position approximately centered at a center point of the platform 920. The motor 930 may, however, be positioned in any manner sufficient to enable the motor 930 to alter the position and/or orientation of the surface 920. In one example, the motor 930 is a rotational or angular motor that causes the platform 920 to rotate about an axis that is substantially orthogonal to the platform 920. Additionally or alternatively, the motor 930 can be a linear motor or other motor operable to displace the platform 920 in two- or three-dimensional space.

The controller 20 is communicatively coupled to the motor 930 and configured to obtain a measured signal quality associated with the network communication device 910 and to cause the motor 930 to alter the respective orientations of the network communication device 910 and the platform 920 in response to the measured signal quality. In an aspect, the controller can obtain and/or utilize signal quality information in providing movement instructions to the motor 930 in a similar manner to that described above with respect to system 700 in FIG. 7.

In another aspect, the controller 20 is configured to instruct movement of the platform 920 via the motor 930 according to a set of movement constraints that define valid orientations for the platform 920 and/or wireless communication device 910. By way of non-limiting example, if the platform 920 is configured for rotation via the motor 930, the movement constraints can define a permissible range of rotation for the platform 920. The permissible range of rotation can be predefined and/or otherwise fixed, or alternatively the permissible range of rotation can be set based on user preferences, properties of the wireless communication device 910, and so on. For instance, a wireless router and/or other device having multiple input cables can be configured with a smaller range of rotation than a mobile phone and/or other similar device with fewer or no input cables in order to prevent damage to the wireless communication device 910 and/or its associated input cables due to over-rotation. The properties of the wireless communication device 910 could be provided manually by a user (e.g., during an initial configuration), obtained directly from the wireless communication device 910, and/or obtained in any other suitable manner. Other considerations could also be used. Additionally, a permissible range of linear or other non-rotational motion could be defined in a similar manner.

The controller 20 can provide movement instructions to the motor 930 through any suitable means for conveying information between the controller 20 and motor 930. In one example, the controller 20 can be integrated into the platform 920 and/or motor 930 and provide movement instructions to the motor 930 via a system bus, a PCB, and/or other similar means. In another example, the controller 20 is communicatively coupled to the motor 930 through a wired communication link between the controller 20 and motor 930. In still another example, a wireless communication link can be established between the controller 20 and motor 930 by the use of antennas (not shown) at the controller 20 and the motor 930 and/or platform 920. In the latter example, the antenna(s) associated with the controller 20 and the antenna(s) associated with the platform 920 and/or motor 930 can be distinct from any antennas associated with the wireless communication device 910.

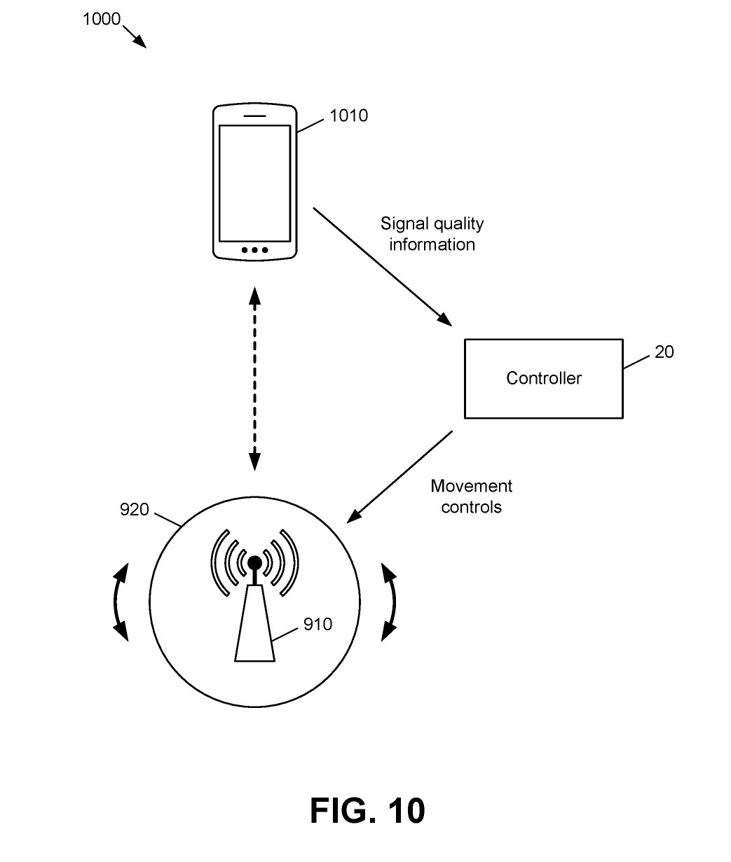

In an aspect, the controller 20 in system 900 can obtain signal quality information corresponding to the wireless communication apparatus 910 directly from the wireless communication apparatus 910, e.g., by listening for system data, diagnostic information, or the like as transmitted from the wireless communication apparatus 910, by submitting a request for signal quality information to the wireless communication apparatus 910, and/or by any other suitable means. In another aspect, as illustrated by system 1000 in FIG. 10, the controller 20 can obtain signal quality information from one or more user or client devices 1010 that are in communication with the wireless communication apparatus 910. In one example, signal quality information can be transmitted from device 1010 to the controller 20 automatically at scheduled and/or otherwise regular intervals. In another example, the device 1010 can locally monitor its own signal quality associated with the wireless communication apparatus 910 and transmit signal quality information to the controller 20 if the signal quality falls below a threshold. In still another example, signal quality information can be provided to the controller 20 in response to a user command received at either the device 1010 or the controller 20.

In response to the signal quality information received from the device 1010, the controller 20 instructs movement of the platform 920 as generally described above. While FIG. 10 illustrates a non-limiting example of a rotating platform, other types of movement are also possible.

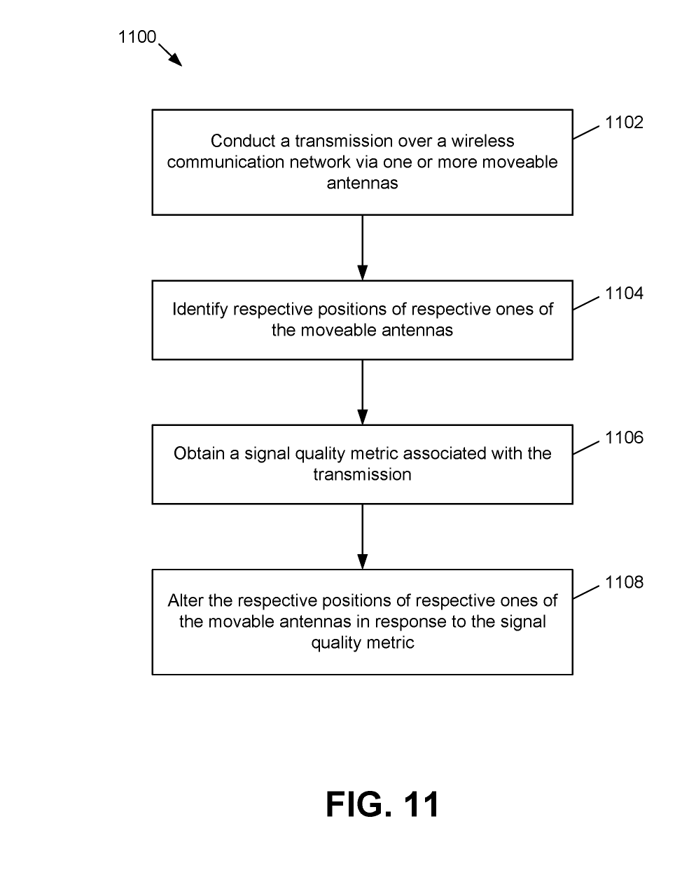

With reference next to FIG. 11, a flow diagram of a method 1100 for managing a network communication apparatus, e.g., an apparatus having antennas 10 and/or a wireless communication apparatus 910, is illustrated. At 1102, a transmission is conducted over a wireless communication network via one or more movable antennas. As noted above, the wireless communication network can utilize any suitable wireless communication protocol(s) or standard(s), such as Wi-Fi, Bluetooth, and/or any other protocol(s) or standard(s). In an aspect, the antennas can be movable independently (e.g., as shown by FIG. 6) and/or as a unit with a device utilizing the antennas, e.g., by a platform.

At 1104, a signal quality metric (e.g., RSSI, PER, etc.) associated with the transmission conducted at 1102 is obtained. The signal quality metric can be obtained from a device to be adjusted (e.g., a device having antennas 10 and/or a wireless communication apparatus 910), one or more devices communicating with a device to be adjusted (e.g., a device 1010), and/or other device(s) or source(s).

At 1106, the respective positions of the movable antennas are altered in response to the signal quality metric received at 1104. In an aspect, the new positions of the movable antennas may be selected at 1106 based on a set of movement constraints for the antennas, a set of candidate antenna positions, and/or other considerations.

In the present specification, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time.

What has been described above includes examples of one or more embodiments of the disclosure. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A network communication apparatus, comprising:
one or more antennas respectively configured for communication according to at least one network communication protocol;
a movable surface coupled to respective antennas, the movable surface configured to alter respective orientations of the respective antennas according to a set of movement constraints that defines a plurality of valid orientations for the respective antennas; and
a controller communicatively coupled to the respective antennas and the movable surface, the controller configured to obtain a measured signal quality associated with the respective antennas and to cause the movable surface to alter the respective orientations of the respective antennas in response to the measured signal quality.

2. The network communication apparatus of claim 1, wherein the movable surface comprises:
a mounting platform adapted to receive the one or more antennas; and
a motor coupled to the mounting platform and configured to displace the mounting platform, thereby causing the movable surface to alter the respective orientations of respective antennas.

3. The network communication apparatus of claim 2, wherein the motor is further configured to rotate the movable surface about an axis substantially orthogonal to the mounting platform.

4. The network communication apparatus of claim 3, wherein the set of movement constraints defines a maximum range of angular displacement of the motor, the maximum range of angular displacement being less than 360 degrees.

5. The network communication apparatus of claim 1, wherein the controller comprises a microcontroller associated with a wireless communication protocol utilized by the one or more antennas.

6. The network communication apparatus of claim 1, wherein the measured signal quality comprises a signal quality associated with one or more devices communicating with the network communication apparatus.

7. The network communication apparatus of claim 5, wherein the controller is further configured to obtain respective signal qualities for a plurality of candidate antenna orientations and to select a candidate antenna orientation associated with a highest measured signal quality.

8. The network communication apparatus of claim 6, wherein the controller is further configured to monitor the measured signal quality and to obtain the signal qualities for the plurality of candidate antenna orientations in response to the measured signal quality falling below a threshold.

9. The network communication apparatus of claim 1, wherein the one or more antennas, the movable surface, and the controller are housed within a router.

10. The network communication apparatus of claim 1, wherein the one or more antennas, the movable surface, and the controller are housed within a network signal extender.

11. An apparatus, comprising:
a platform having a first surface adapted to receive a network communication device;
a motor coupled to the platform and configured alter respective orientations of the platform and the network communication device according to a set of movement constraints that defines a plurality of valid orientations for the network communication device; and
a controller communicatively coupled to the motor and configured to obtain a measured signal quality associated with the network communication device and to cause the motor to alter the respective orientations of the network communication device and the platform in response to the measured signal quality.

12. The apparatus of claim 11, wherein the motor is further configured to rotate the platform about an axis substantially orthogonal to the first surface of the platform.

13. The apparatus of claim 12, wherein the controller is configured to cause the motor to rotate the platform within a maximum range of angular displacement, the maximum range of angular displacement being less than 360 degrees.

14. The apparatus of claim 11, wherein the controller is communicatively coupled to the network communication apparatus and obtains the measured signal quality from the network communication apparatus.

15. The apparatus of claim 11, wherein the controller obtains the measured signal quality from one or more devices communicating with the network communication apparatus.

16. A method of managing a network communication apparatus, the method comprising:
conducting a transmission over a wireless communication network via one or more movable antennas;
identifying respective positions of respective movable antennas;
obtaining a signal quality metric associated with the transmission; and
altering the respective positions of the respective movable antennas in response to the signal quality metric.

17. The method of claim 16, wherein:
the identifying comprises identifying respective angular positions of the respective movable antennas relative to a reference point; and
the altering comprises rotating the respective movable antennas about an axis defined at least in part by the reference point.

18. The method of claim 16, wherein the obtaining comprises obtaining at least one of a received signal strength indicator (RSSI) or a packet error rate (PER) associated with the transmission.

19. The method of claim 16, wherein:
the obtaining comprises obtaining respective signal quality metrics for respective transmissions corresponding to a plurality of candidate antenna configurations; and
the altering comprises altering the respective positions of the respective movable antennas according to a candidate antenna configuration having a highest signal quality metric.

20. The method of claim 19, further comprising:
monitoring for changes to the signal quality metric; and
repeating the obtaining and the altering in response to the signal quality metric falling below a threshold.
